(19) United States
(12) Patent Application Publication
(10) Pub. No.: US 2004/0046385 A1
(43) Pub. Date: Mar. 11, 2004

(54) Low profile junction box connector

(76) Inventor: Sami Shemtov, Aventura, FL (US)

Correspondence Address: HOWARD C. MISKIN, C/O STOLL, MISKIN, & BADIE, THE EMPIRE STATE BUILDING, 350 FIFTH AVENUE SUITE 4710, NEW YORK, NY, 10118, US

(21) Appl. No.: 10/235,375

(22) Filed: Sep. 5, 2002

(51) Int. Cl. F16L 3/04

(52) U.S. Cl. 285/139.1

(57) ABSTRACT

A low profile connector for interconnecting a wire carrying conduit to a junction box. The connector includes a tubular casing having a front and end sections of enlarged and reduced diameters, respectively, and a locknut that cooperatively mates with the enlarged section of the tubular casing. The enlarged end of the tubular casing is internally threaded to receive the locknut. The reduced section of the tubular casing receives a wire carrying conduit. An internally threaded, radially positioned, opening at the end section of the tubular casing accepts a set screw for securing the wire carrying conduit received in the tubular casing. The locknut includes a tubular body having a front and end sections, with a curved flange at the front section and an externally threaded end section which cooperatively mates with the enlarged section of the tubular casing. The end section of the locknut has an internally extending rim that abuts the wire carrying conduit received in the tubular casing.

### FIELD OF THE INVENTION

The invention relates to a connector that interconnects a conduit containing electrical cables and wires to an electrical junction box. In particular, an improved connector that is easy to attach to an electrical junction box, has a low profile and allows ease in fastening and ease in mass manufacturing at a low cost.

### BACKGROUND OF THE INVENTION

An electrical junction box provides an interface for electrical cables from a central power distribution center to customers throughout a building served by the junction box. Numerous cables and wires contained in a generally cylindrical conduit enter and exit a junction box through openings on the walls of the junction box.

Connectors are used to properly and fixedly position and connect a conduit containing cables and wires to the junction box in order to establish electrical contact between the terminals of various wires running through one or more conduits in the junction box. It is therefore essential that not only the conduit connector or connectors terminate in the junction box but that measures be taken to prevent axial pullout or dislocation of the connector from the junction box which will place a strain on the electrical connections between various conductors carried by the conduits. Further, since a large number of cables and wires are usually crammed into an electrical junction box that, it is essential that a connector has a low profile to conserve space within the junction box and is easy to attach to the junction box to facilitate the handling of the numerous cables and wires.

U.S. Pat. No. 5,165,735 issued on Nov. 24, 1992 to Pierre Nardi et al. describes a prior art connector which typically includes a cylindrical body which is attached to the junction box by inserting the externally threaded end of the tubular body through an opening of the junction box, which is then secured with a locknut. A conduit is secured to the opposite end of the tubular body with a clamp, screw and washer. Another similar prior art connector is shown in U.S. Pat. No. 3,333,501 issued on Aug. 1, 1967 to H. H. Pitcher. These prior art connectors contain multiple parts, are complicated to manufacture and assemble, difficult to use and have a high profile that may interfere with the cables and wires contained in the junction box. Also, since the majority of these prior art connectors are molded, they are susceptible to breakage, if receiving any blow.

Therefore, there is a need for a connector that is easy to attach to an electrical junction box, strong, has a low profile and allows ease in fastening and ease in mass manufacturing at a low cost.

### SUMMARY OF THE INVENTION

The present invention provides a junction box connector having minimal parts that are easy to assemble and manufacture at a low cost and has a low profile when attached to a junction box.

The connector of the present invention comprises a tubular casing having a front and end sections of enlarged and reduced diameters, respectively, and a locknut that cooperatively mates with the enlarged section of the tubular casing. The enlarged end of the tubular casing is internally threaded to receive the locknut. The reduced section of the tubular casing is adapted to receive a wire carrying conduit. An internally threaded, radially positioned, opening at the end section of the tubular casing is adapted to accept a set screw for securing the wire carrying conduit received in the tubular casing. The locknut comprises a tubular body having a front and end sections, with a curved flange at the front section and an externally threaded end section which cooperatively mates with the enlarged section of the tubular casing. The end section of the locknut has an internally extending rim that is adapted to abut the wire carrying conduit received in the tubular casing.

With the front section of the tubular casing abutting one side of an opening on the junction box, the locknut is inserted through the opening from the opposite side of the opening to engagingly mate with the front section of the tubular casing. Thereby, sandwiching the wall of the junction box between the flange of the locknut and the front section of the tubular casing for securely attaching the connector to the junction with a low profile.

The tubular casing and locknut of the present invention are preferably stamped, extruded or molded for ease of manufacturing at a low cost. Further, the connector of the present invention being a one piece steel extrusion, is strong and can be subject to severe abuse with no effect.

### BRIEF DESCRIPTION OF THE DRAWINGS

A preferred embodiment of the present invention has been chosen for purposes of illustration and description and is shown in the accompanying drawings forming a part of the specification wherein:

FIG. 1 is a cross sectional view of the connector of the present invention.

FIG. 2 is a cross sectional view of the tubular casing of the present invention.

FIG. 3 is a side view taken from line 3-3 in FIG. 2.

FIG. 4 is a cross sectional view of the locknut of the present invention.

FIG. 5 is a side view taken from line 5-5 in FIG. 4.

FIG. 6 is a top view taken from line 6-6 in FIG. 5 illustrating the bend comers of each tooth of the locknut.

### DETAILED DESCRIPTION OF THE PREFERRED EMBODIMENTS

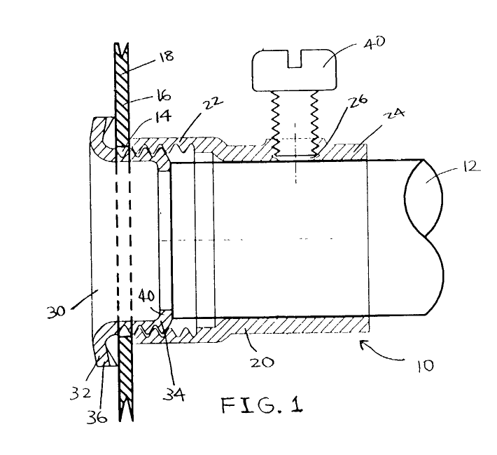

With reference to the drawings, wherein the same reference number indicates the same element throughout, there is shown in FIG. 1 a cross sectional view of the connector 10 of the present invention attaching a wire carrying conduit 12 to an opening 14 on a wall 16 of a junction box 18. As shown in FIG. 1, the connector 10 includes a tubular casing 20, a locknut 30 and a set screw 40.

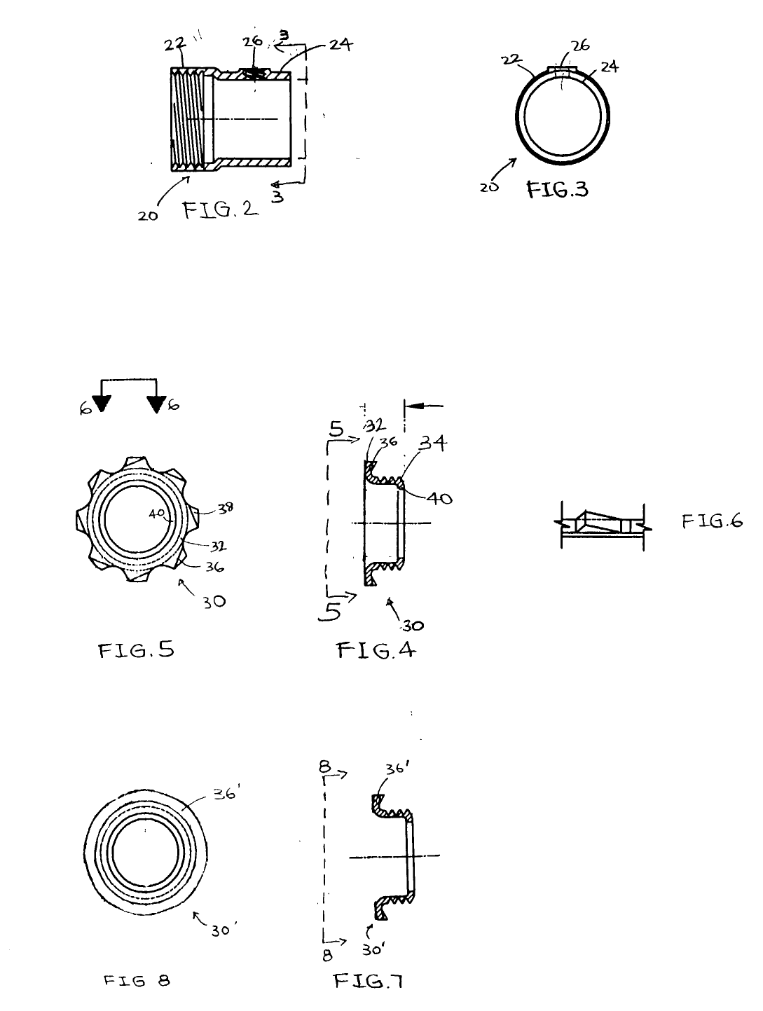

As shown in FIGS. 2 and 3, the tubular casing 20 has a front section 22 with an enlarged diameter and an end section 24 with a slightly reduced diameter. The internal diameter of the end section 24 is sized to receive a corresponding wire carrying conduit 12 of a predetermined diameter (as shown in FIG. 1). The front section 22 is internally threaded to receive locknut 40 (as shown in FIG. 1). At the end section 24, an internally threaded, radially positioned, opening 26 is provided to receive a set screw 40 for securing the conduit 12 (as shown in FIG. 1).

As shown in FIGS. 4 and 5, the locknut 30 has a tubular body with a front section 32 and an end section 34. Extending radially from the front section 32 is a flange 36 comprising a plurality of teeth 38. The flange 36 is slightly curved towards the end section 34. The end section 34 is externally threaded which cooperatively mates with the internal threading of the enlarged front section 22 of the tubular casing 20 (as shown in FIG. 1). A rim 40 extends radially inward from the end section 34. Rim 40 is adapted to abut the conduit 12 received in tubular casing 20 and is dimensioned to be slightly smaller that the predetermined diameter of the conduit 12 (as shown in FIG. 1) to prevent the conduit 12 from protruding into the junction box 18.

FIG. 6 illustrates that each teeth 38 of the flange 36 has a bend corner that improves the handling of the locknut 30 when securing the locknut 30 to the tubing casing 20.

As shown in FIG. 1, when the connector 10 is in use, the front section 22 of the tubular casing 20 is positioned adjacent the opening 14 on one side of the wall 16 of the junction box 18, and the end section 34 of the locknut 30 is inserted through the opening 14 from the opposite side of the wall 16 to threadedly mate with the front section 22 of the tubular casing 20. Thereby, sandwiching the wall 16 between the tubular casing 20 and the locknut 30 to secure the connector 10 to the junction box 18. With the locknut 30 being threaded into the tubular casing 20, the connector 10 has a low profile that converse space within the junction box 18. The curved flange 36 advantageously provides improved contacts between the locknut 30 and the wall 16 of the junction box 18. To interconnect a conduit 12 with the junction box 18, the conduit 12 is inserted into the tubular casing 20 from the end section 24 until it abuts the rim 40 of the locknut 30. The set screw 40 may be tightened to securely attached the conduit 12 within the tubular casing 20.

FIGS. 7 and 8 illustrate an alternate locknut 30′ similar to the locknut 30 of FIGS. 4 and 5 with a slightly curved flange 36′ that radially extends from the front section 32.

In view of the simple structure of the tubular casing 20 and lock nut 40, the connector 10 of the present invention may be advantageously stamped or extruded from a tubular shaped material or molded. Thereby, substantially lowering the cost of manufacture.

The features of the invention illustrated and described herein is the preferred embodiment. Therefore, it is understood that the appended claims are intended to cover unforeseeable embodiments with insubstantial differences that are within the spirit of the claims.

What I claim is:

1. A connector for interconnecting a wire carrying conduit to a junction box, comprising:
a one piece tubular casing having a front section of an enlarged diameter and an end section of a reduced diameter, said enlarged front section being internally threaded; and
a locknut having a tubular body with a front section and an end section, and a flange extending radially from the front section of said tubular body and curving towards said end section of said tubular body, said end section of said tubular body being externally threaded to cooperatively mate with said enlarged front section of said tubular casing.

2. The connector of claim 1 wherein said reduced end section of said tubular casing is adapted to receive said wire carrying conduit.

3. The connector of claim 2, wherein said reduced end section of said tubular casing having an internally threaded, radially positioned, opening adapted to secure said wire carrying conduit.

4. The connector of claim 3, wherein said reduced end section having means for securing said wire carrying conduit.

5. The connector of claim 4, wherein said securing means comprises a set screw threaded through said opening of said reduced end section of said tubular casing.

6. The connector of claim 2, wherein said end section of said tubular body further having an internally extending rim adapted to abut said wire carrying conduit received is said tubular casing.

7. The connector of claim 1, wherein said tubular casing and said locknut are stamped from a tubular shaped material.

8. The connector of claim 1, wherein said tubular casing and said locknut are extruded from a tubular shaped material.

9. The connector of claim 1, wherein said tubular casing and said locknut are fabricated by molding.

10. A connector for interconnecting a wire carrying conduit to a junction box, said junction box having at least one opening for receiving said connector, comprising:
a one piece tubular casing having a front section of an enlarged diameter and an end section of a reduced diameter adapted to receive said wire carrying conduit, said enlarged front section being internally threaded and is positioned adjacent said opening of said junction box; and
a locknut having a tubular body with a front section and an end section, and a flange extending radially from the front section of said tubular body and curving towards said end section of said tubular body, said end section of said tubular body being externally threaded and positioned adjacent an opposite side of said opening of said junction box to cooperatively mate with said enlarged front section of said tubular casing, whereby enclosing said opening of said junction box between said flange of said locknut and said front section of said tubular casing for securely attaching said connector to said junction box.
